(19) United States
(12) Patent Application Publication
(10) Pub. No.: US 2009/0052712 A1
(43) Pub. Date: Feb. 26, 2009

(54) Stabilized Deployable-Retractable System, Principally for an Acoustic Loudspeaker System

(75) Inventor: Yves Trelohan, Orvault (FR)

Correspondence Address: BROWDY AND NEIMARK, P.L.L.C.;624 NINTH STREET, NW, SUITE 300, WASHINGTON, DC, 20001-5303, US

(73) Assignee: SCREEN RESEARCH, La Chapelle sur Erdre (FR)

(21) Appl. No.: 11/662,271

(22) PCT Filed: Sep. 8, 2005
(86) PCT No.: PCT/IB05/03917

§ 371 Date: Mar. 9, 2007

(30) Foreign Application Priority Data
Sep. 9, 2004 (FR) 0409574

(51) Int. Cl. H04R 1/02

(52) U.S. Cl. 381/333

(57) ABSTRACT

A deployable-retractable assembly comprising a base, a mobile sound generation system which is elongated along a reference direction, intended to be used with a projection screen and intended to be moved between a retracted position and a deployed position along a generally vertical translation direction transverse to the reference direction, and a movement control system to drive the movement of the mobile sound generation system relative to the base along this translation direction, wherein the movement control system comprises a roll-up retention device which has a roll-up axis transverse to the translation direction and which is stretched between the base and the mobile sound generation system, and a self-guided stabilization mechanical device linked to the base and to the mobile sound generation system, deformable within a plane at least approximately parallel to the translation direction and the roll-up axis and also significantly stiff transversally to this plane, with at least one of these devices equipped with a drive mechanism.

The invention is a stabilised deployable-retractable system, preferably for a sound system.

It is primarily, but not exclusively, targeted at multimedia applications; it is also applicable in situations that require deployment or retraction over a significant distance (typically 50 cm to a few meters) and that need to be guided or that need a tight locational precision during movement and/or high stability in any stopped position (fully open/closed, deployed/retracted, or any intermediate position). One can consider applications concerning remote movement of elements like lighting rigs, or observational systems (cameras, etc); one can also imagine applications where one wants to deploy or store an assembly which is itself deployable-retractable, for example a projection system, with or without a sound system, in very large rooms where the ceiling is too tall to install a projection screen.

The domain of sound systems remains an interesting field for the invention as sound systems are used by many people, in both domestic and professional environments.

These systems, which originated as single-speaker, have progressively evolved into stereophonic systems (2 sources of sound emission) or multichannel systems (5, 6, 7 or 8 sources), particularly in Cinema or Home Cinema applications.

These sound systems can be problematically cumbersome or ugly in particular environments.

One possible solution consists of integrating these systems inside walls (commonly called <<in-wall>> speakers). Most speaker manufacturers have developed models specifically designed for this application. But this solution is not always applicable or desirable.

One could be tempted to base a design on that of retractable screens, but the general shortcoming of existing systems of screen retraction is that they cannot prevent oscillations (one must keep in mind that the production of sound waves implies by necessity oscillations, so the position of the loudspeakers must be sufficiently rigid so that they do not oscillate themselves). In addition, the screen retraction systems prove, in practice, to be too imprecise to ensure that speaker systems, give their volume and inertia, store themselves precisely in their casing.

The goal of the invention is to solve the problems cited above.

In general the object of the present invention is to propose a stabilized deployable-retractable system that can drive a precise and stable deployment of a mobile element (a speaker system, or any other type of element) and also offer a stable positioning of this mobile element in its deployed position(s).

The invention proposes a deployable-retractable system including a base, a mobile sound generation system which is elongated along a reference direction, intended to be used with a projection screen and intended to be moved between a retracted position and a deployed position along a generally vertical translation direction transverse to the reference direction, and a movement control system to drive the movement of the mobile sound generation system relative to the base along this translation direction, wherein the movement control system comprises a roll-up retention device which has a roll-up axis transverse to the translation direction and which is stretched between the base and the mobile sound generation system, and a self-guided stabilization mechanical device linked to the base and to the mobile sound generation system, deformable within a plane at least approximately parallel to the translation direction and the roll-up axis and also significantly stiff transversally to this plane, with at least one of these devices equipped with a drive mechanism. Quite preferably, the mobile sound generation system can be of significant weight and the retention mechanism and the stabilization mechanism act in different, offset planes, creating a moment. The combination of the offset between the retention system and the stabilization system and the rigidity of the stabilization mechanism can be arranged to be able to handle significant loads (20-80 kg); this is necessary in the field of acoustics and Home Cinema as loudspeakers need a certain weight to achieve optimal acoustic inertia. The variability of the resulting moment as a function of the offset and the rigidity enables this system to be used for many different applications in different fields for various elements of various weights.

According to the preferred embodiments of the invention, together or separate:

the stabilization device is mounted between the base and the mobile system in order to urge the mobile element, against the retention system; this contributes to the stability of the system in the deployed position;

the self-guided stabilization device contains elastic elements urging the device in the direction of deployment in order to take up play in the system, which lends certain elasticity to the stabilization effect;

the self-guided stabilization device and the roll-up retention device act upon the mobile system in zones which are not parallel to the plane defined by the translation direction and the roll-up axis, in order to generate a moment relative to this roll-up axis; the resulting friction at the interfaces between the different mobile parts improves the stability;

the roll-up retention device contains elastic components which apply a force in the direction of retraction; this also improves the effect cited above;

the self-guided stabilization device contains arms which are articulated perpendicular to the plane in which the system extends, which is a practical configuration;

these arms are independent; alternatively, these arms are articulated together, to create a pantograph;

the roll-up retention device contains at least one pair of cables which roll around the said roll-up axis; alternatively the roll-up retention device contains at least one strap which rolls around the said roll-up axis;

the roll-up axis and the reference direction are parallel and horizontal, which is the simplest case;

the device provided with the drive mechanism is the roll-up retention device; alternatively, the device provided with the drive mechanism is the self-guided stabilization mechanism;

the movement control system contains at least one actuator;

the mobile system moves below the base; alternatively, the mobile element moves above the base, with an upwards deployment;

the base contains a deployable-retractable projection screen; preferably this screen is equipped with a drive mechanism which is independent of the movement control system of the mobile system;

the screen is advantageously acoustically transparent and extends, when deployed, in front of the mobile system in its deployed position;

the screen is attached to the mobile element;

in this case, the roll-up retention device is advantageously the screen itself; alternatively, the roll-up retention device is positioned behind the screen;

the mobile system deploys downwards from the base; alternatively, the mobile element deploys upwards from the base;

the base is a cabinet into which the mobile system can retract in its retracted position;

the mobile sound generation system is a deployable-retractable sound generation and projection sub-assembly.

the mobile sound generation system is a platform adapted to receive one or more sound generation devices.

It should be noted that the precision offered by the system permits both precise movement in space as well as stability of the mobile element during use, which is necessary for high-quality sound production. This precision is also particularly interesting when the mobile element is used in proximity with other elements in space, such as but not exclusively, a projection screen, because it obviates the need for excessive clearance between the mobile element and other elements. This allows, for example, but not exclusively, optimally close placement of the loudspeakers near a projection screen.

It should be noted that this system can also be used for other applications wherever the same effects are desired (deployment or removal of an observation system, or a multimedia system, see above).

The sound production system can be indifferently composed of one or more standard acoustic speakers, possibly mechanically joined, or resting on a support platform, or of a speaker system specifically developed for use in a retractable system. This sound production system may alternatively be such a support platform adapted to receive one or more sound devices.

The drive mechanism which enables the movement from the retracted position to the deployed position can be, for example, a roll-up tube, equipped with a manual or motorized drive mechanism, which can indifferently be integrated into the tube, with one or more cables or straps wrapped around the tube which are linked to the mobile element.

The stabilization system can be composed of mechanical guide arms, as are used in awnings, or of a pantograph, which ensures guidance of the movement of the mobile element, as well as the uniformity of positioning of the system, in both the stowed and deployed positions.

The mechanical arms also aim to maintain the mobile element in a stable position both in the retracted position as well as in the deployed position.

The stabilization system can also be equipped with a system such as springs or cylinders which constrain the mobile element improving its stability and limiting the undesirable noises that are created between it and its mechanical parts. These noises are both limited during the deployment phase and retraction phrase as well as in the retracted and deployed positions. This constraint has the effect of limiting or suppressing the play between mechanical parts

This constraint can also result from other techniques such as electromagnetic forces.

Objects, characteristics and advantages of the invention result from the description below, shown as a non-exclusive example, in regards to the attached drawings on which:

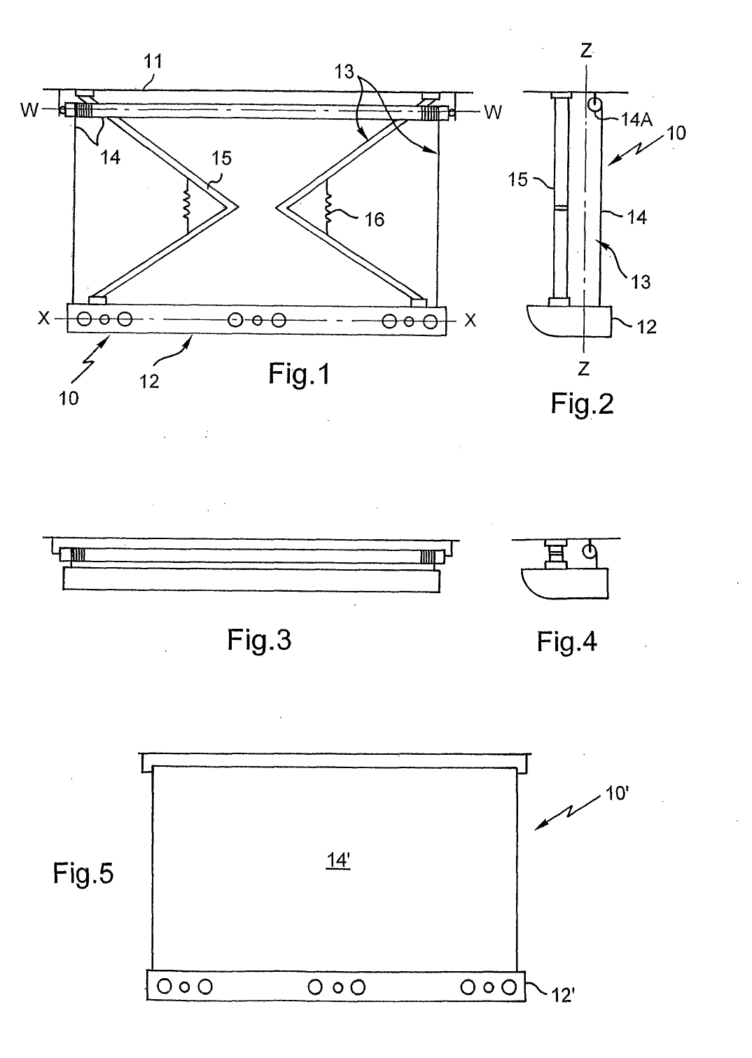

FIG. 1 is a front view of a deployable-retractable system according to the invention in its deployed position, according to a first embodiment, wherein the mobile element is an acoustic speaker system,

FIG. 2 is a side view,

FIG. 3 is a front view, in the retracted position,

FIG. 4 is a side view, in the retracted position,

FIG. 5 is a front view of another embodiment of a deployable-retractable system according to the invention,

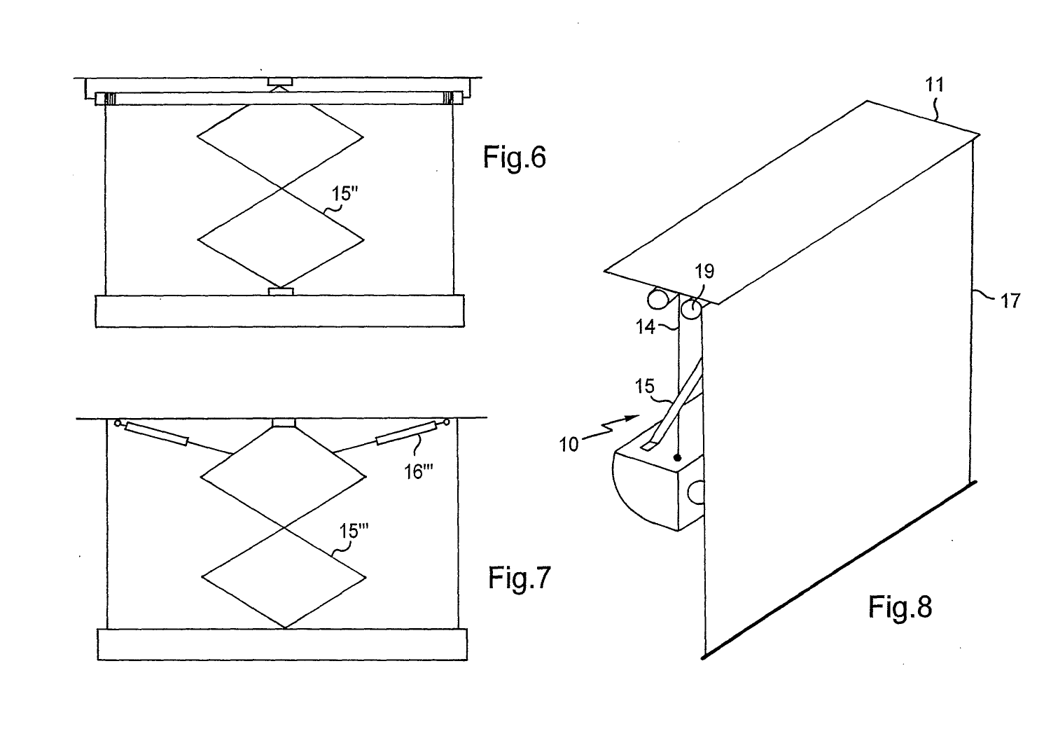

FIG. 6 is a front view representing a variation of the system of articulated arms from FIGS. 1 to 4,

FIG. 7 is a front view of a preferred embodiment of FIG. 6,

FIG. 8 is a perspective view of the system according to FIGS. 1 to 4, combined with an independent projection screen,

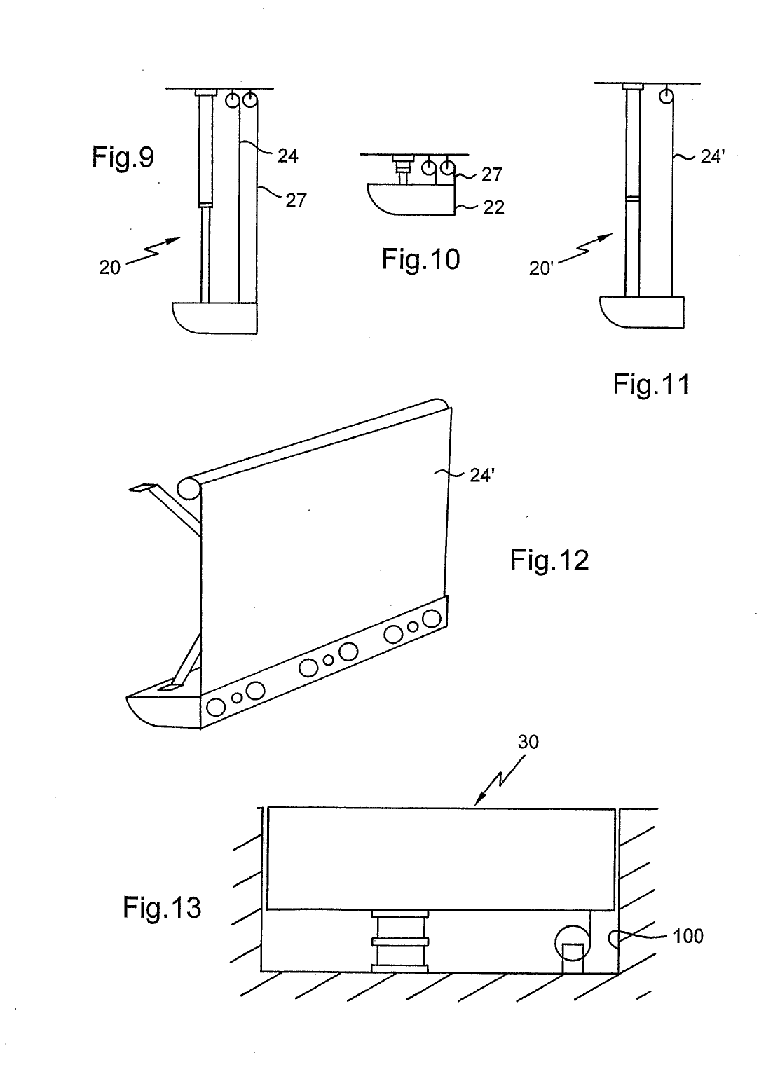

FIG. 9 is a side view of a system combining FIGS. 1 to 4 and a screen attached to the base and to the mobile element, in the deployed position,

FIG. 10 is a view in the retracted position,

FIG. 11 is a side view of a system analogous to that of FIG. 5 where the strap is a projection screen, in deployed position,

FIG. 12 is a perspective view in the deployed position,

FIG. 13 is a view in retracted position, of a variation of FIG. 11 wherein the mobile element deploys upwards from the base,

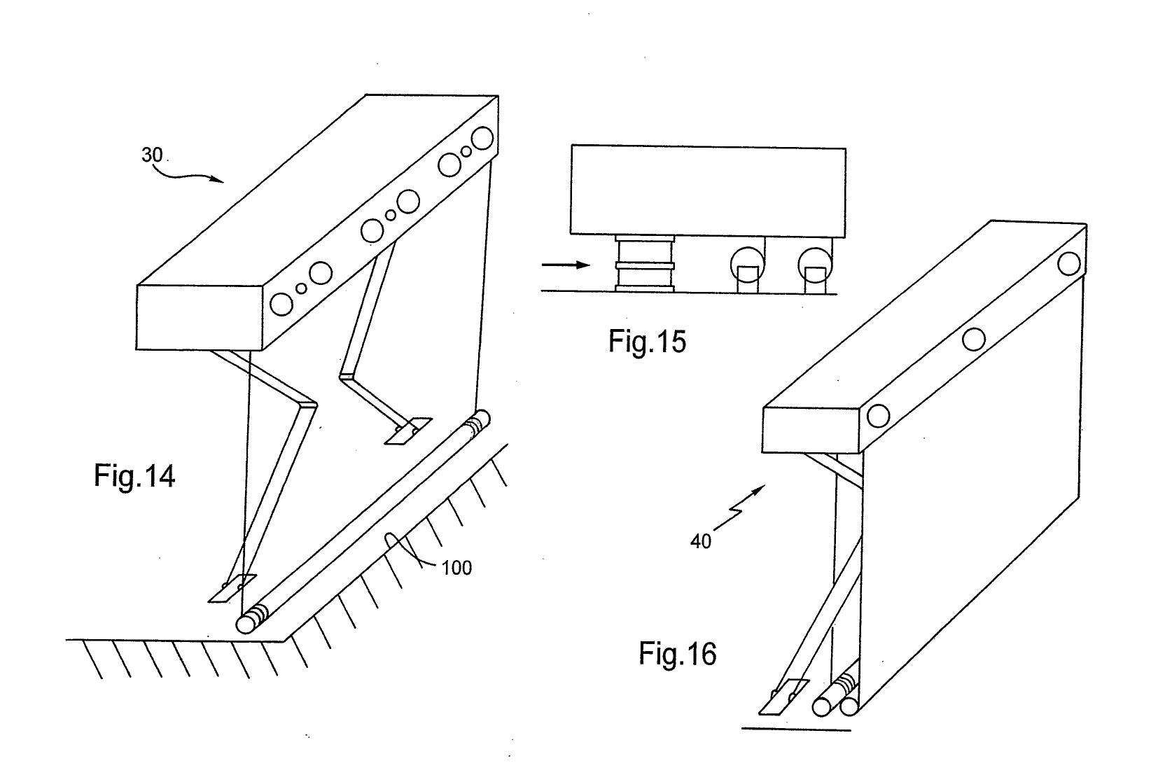

FIG. 14 is a view in perspective, in the deployed position,

FIG. 15 is a view, in retracted position, of a variation of FIG. 9 in which the mobile element deploys upwards from the base,

FIG. 16 is a perspective view, in deployed position,

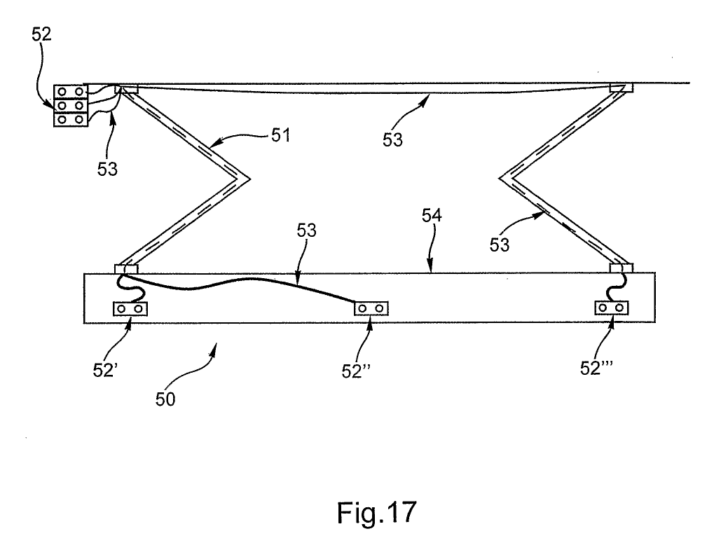

FIG. 17 is a view of a variation where the sound generation system is a mere platform without sound devices.

FIGS. 1 to 4 show the functional principle of a deployable-retractable system according to the invention, item 10.

This system includes

a base 11,

a mobile system 12 elongated along a reference axis or direction X-X and intended to be moved between a retracted position (FIGS. 3 and 4) and a deployed position (FIGS. 1 and 2) along a generally vertical direction of movement Z-Z which is transverse to the reference direction, and

a movement control system 13 to drive the movement of the mobile system relative to the base, along this axis of movement or translation.

According to the invention, this movement control system contains a roll-up retention device 14 which has a roll-up axis of rotation W-W perpendicular to the direction of movement and which is stretched between the base and the mobile system, and a self-guided mechanical stabilization device 15 attached to this base and to the mobile element, deformable in a plane at least approximately parallel to the direction of movement and to the axis of rotation (here, parallel to the sheet with regards to FIGS. 1 and 3) which is also significantly stiff transverse to this plane (therefore left to right and vice-versa on FIGS. 2 and 4), with at least one of these devices equipped with a drive mechanism.

As an example, this mobile sound generation system is about 1.8 m long.

The invention is particularly interesting in multimedia applications, where the mobile system is an acoustic speaker system, for example comprising the sound sources for a Home Cinema system, and, in particular, one or more of the front channels of such a system. This is shown in the figures by circles which represent various speakers.

This mobile sound generation system may have a significant weight (possibly from 30 to 70 kg).

In this embodiment, the base 11 is attached to the ceiling of any ordinary room, and the roll-up retention mechanism 14 is made of cables rolling on the drive tube 14A concentric with the axis W-W. As an alternative, the base is a portion of such ceiling.

To ensure that the cables roll up precisely on the tube, one can imagine a guidance system, such as a ring which slides parallel to this tube to guarantee that the roll-up diameter remains constant and equal to the outside diameter of the tube, and also to ensure precise lateral positioning (see FIG. 1).

Here, this tube is one continuous tube, but it is understood that a variation can have discrete roll-up mechanisms for each cable. <<Cable >> can be understood to be any flexible, elongated element with little or no elasticity, such as a cable, a strap, etc.

As regards the self-guided stabilization mechanism 15, here it is composed of arms which are articulate perpendicular to the plane in which this mechanism is deformable, that is the arms are articulated around short axes which are perpendicular to the plane of deformation.

Here these arms 15 are independent and respectively attached to the ends of the base and the mobile system, with central joints which are adjacent in the retracted position but maximally distant from each other in the deployed position.

It is clear that since the deformation is confined to one plane (or a thin area of space) the result is a guided deployment (of the arms as well as the mobile system) parallel to this plane with a significant stiffness perpendicular to this plane, which helps to reduce the potential parasitical movements of the mobile element perpendicular to this plane. When the self-guided stabilization mechanism is composed of articulated arms, this transversal stiffness is proportional to the transversal length of the axes and inversely proportional to the play in the joints.

In this embodiment, the drive mechanism is the same as the roll-up retention system, whose tube constitutes the said drive mechanism, with the cables being unrolled by the gravitational forces applies to the mobile element.

Advantageously, the self-guided stabilization mechanism is mounted between the base 11 and the mobile element 12 in order to apply at least a compressive force to the mobile element, against the retentive action of the roll-up retention mechanism. This effect can be obtained by elastic elements which apply a force to the mechanism in the direction of deployment, which takes up the potential play between the various mechanical elements of the system. In the example of FIGS. 1 to 4, these elastic elements are advantageously placed inside the structure of the arms and are, in FIG. 1, represented for the sake of clarity as springs 16 compressed between the members of each arm. It is understood that these can be replaced by elastic elements mounted between the members and the base, and/or the mobile element.

We can note that in this case, as well as in that in FIG. 2 (see also FIG. 4), the elements 14 and 15 are arranged in order to act on the mobile element in areas that are not aligned parallel to the plane defined by the direction of movement Z-Z and the axis of rotation W-W. In fact, the force applied by the element 15 is located to the left of the retention force applied by the element 14. A moment is therefore applied to the mobile element relative to the axis of rotation with contributes to reducing the potential play in the joints and therefore improves the stability of the mobile element perpendicular to the plane defined by the axes Z-Z and W-W. The combination of the offset between the retention system and the stabilization system and the rigidity of the stabilization mechanism can be arranged to be able to handle significant loads. The variability of the resulting moment as a function of the offset and the rigidity enables this system to be used for many different applications in different fields for various elements of various weights.

In the example presented, the compressive forces on one hand and the tensile forces on the other hand are applied in two parallel planes (see FIG. 2), but it must be understood that in another variation (not presented here), there can be any number of zones of compression or tension, which can indifferently on either side of one another.

FIG. 5 is a schematic representation of an assembly, called 10′, which differs from that of FIGS. 1 to 4 by the fact that the roll-up retention mechanism is a sheet 14′ rolled around a drive tube. As we will see below, this sheet can have a functional role in the assembly (it can be a projection screen in association with an acoustic speaker system which comprises the mobile element).

FIG. 6 represents a different embodiment of FIGS. 1 to 4, wherein the self-guided stabilization mechanism 15″ is no longer made of independent arms, but rather of arms joined together, forming a pantograph.

FIG. 7 represents a different embodiment wherein the drive mechanism is also the self-guided stabilization mechanism. We observe that this mechanism 15′″, here formed by a pantograph as in FIG. 6, is actuated by pistons 16′″ which can act in both directions.

As a variation, these cylinders can act in only one direction, for example with the same function as the elastic elements in FIG. 1, in addition to the drive mechanism with which the roll-up retention mechanism is equipped.

Since we mentioned that the mobile element could be an acoustic speaker system, it may be interesting to integrate a projection screen, also retractable, which can optionally be acoustically transparent.

FIG. 8 represents a system where such a screen 17 is added in front of the deployable-retractable system of FIGS. 1 to 4. In this embodiment this screen 17 is mounted on the base, independently of the deployable-retractable system, with its own drive mechanism, here comprised of a drive tube 19. As is commonly the case, the bottom edge of the screen is equipped with a counterweight bar.

Such a system can be used to view films or filmed concerts, where both the screen and the sound system are deployed, or simply to listen to music, in which case the screen can remain retracted.

If used with an acoustically transparent screen, it would make sense for the sound system to be positioned behind the projection screen when both are deployed for use.

If used with a classic projection screen (non-acoustically transparent), intended mainly to display images from a projector, it would make sense for the sound system to be positioned just below the projection screen, minimizing the distance between the image and the sound source.

FIGS. 9 to 11 represent 2 cases wherein the mobile element is attached, permanently or not, to the bottom edge of the screen, whereby this mobile element helps to correctly stretch the projection screen.

In the assembly 20 in the FIGS. 9 and 10, the bottom portion of a retractable projection screen 27 is attached directly, optionally permanently, to the mobile element 22, independently of the roll-up retention mechanism 24. In this case the movement of the mobile element allows it to unroll the screen, which therefore no longer needs an independent drive mechanism, but simply a spring-loaded return system (not shown), which is much less expensive.

In the assembly 20′ in the FIGS. 11 and 12, the roll-up retention mechanism 24′ is comprised of a sheet (as in FIG. 5) which itself forms a projection screen. We understand that this is equivalent to saying that we use a known motorised retractable projection screen as our roll-up retention system.

Heretofore, we have considered cases where the mobile element, such as the loudspeaker system, is deployed downwards.

It is also understood that the invention also permits the mobile equipment to be deployed upwards; this is shown in FIGS. 13 to 16.

The assembly 30 of FIGS. 13 and 14 represents one embodiment similar to the embodiment of FIGS. 11 and 12, with the only difference being that the deployment is upwards, while the assembly 40 of FIGS. 15 and 16 similarly represents an embodiment similar to that of FIGS. 9 and 10, with the only difference being that the deployment is, as in FIGS. 11 and 12, upwards.

It should be noted that, given the good stability and the high precision of movement and positioning of the mobile element pursuant to the invention, we can anticipate that he base could be a cabinet into which the mobile element (as well as the roll-up retention mechanism and the self-guided stabilisation mechanism) can retract (such a cabinet is represented as item 100 in FIGS. 13 and 14).

FIG. 17 shows one embodiment of the system 50 wherein the mobile element 54 is a platform intended to receive one or more sound generation systems, which can advantageously be loudspeakers. The speaker cables 53 carry the sound signal from the input connector 52 to at least one speaker connector 52′, 52″, or 52′″. The speaker cables can advantageously be routed along or inside the stabilization mechanism 51.

We can note that, according to advantageous characteristics of a deployable-retractable system according to the invention:

this assembly contains a stabilisation system for the assembly which uses opposing forces, creating friction in the stabilisation system

it contains a motorized drive mechanism

it is applied to a loudspeaker system

it is combined with a motorized projection screen

the projection screen is acoustically transparent

the drive mechanism is a retractable or motorized projection screen, and/or

this system also acts as a drive mechanism for a retractable projection screen.

1. Deployable-retractable assembly comprising a base, a mobile sound generation system which is elongated along a reference direction, intended to be used with a projection screen and intended to be moved between a retracted position and a deployed position along a generally vertical translation direction transverse to the reference direction, and a movement control system to drive the movement of the mobile sound generation system relative to the base along this translation direction, wherein the movement control system comprises a roll-up retention device which has a roll-up axis transverse to the translation direction and which is stretched between the base and the mobile sound generation system, and a self-guided stabilization mechanical device linked to the base and to the mobile sound generation system, deformable within a plane at least approximately parallel to the translation direction and the roll-up axis and also significantly stiff transversally to this plane, with at least one of these devices equipped with a drive mechanism.

2. Assembly according to claim 1, wherein the self-guided mechanical device is mounted in between the base and the mobile sound generation system such that it applies at least one thrust on the mobile sound generating system, acting against the force of the retention device.

3. Assembly according to claim 2, wherein the self-guided stabilization mechanical device comprises elastic members which apply effort upon is the device in the direction of deployment in order to nullify mechanical clearances.

4. Assembly according to claim, wherein the self-guided stabilization mechanical device and the roll-up retention device act upon the sound generation mobile system in zones which are not aligned parallel to the plane defined by the translation direction and the roll-up axis, thus creating a moment about said roll-up axis.

5. Assembly according to claim 1, wherein the roll-up retention device comprises elastic members applying force on this device in the direction of retraction.

6. Assembly according claim 1, wherein the self-guided stabilization mechanical device comprises arms which are articulated perpendicular to the plane in which this device is deformable.

7. Assembly according to claim 6, wherein these arms are independent.

8. Assembly according to claim 6, wherein these arms are joined together, so as to form a pantograph.

9. Assembly according to claim 1, wherein the roll-up retention device comprises at least two cables which are rolled around said roll-up axis.

10. Assembly according to claim 1, wherein the roll-up retention device comprises at least one strap which is rolled around said roll-up axis.

11. Assembly according to claim 1, wherein the roll-up axis and the reference direction are parallel and horizontal.

12. Assembly according to claim 1, wherein the device provided with the drive mechanism is the roll-up retention device.

13. Assembly according to claim 1, wherein the device provided with the drive mechanism is the self-guided stabilization mechanical device.

14. Assembly according to claim 13, wherein the movement control system includes at least one actuator cylinder.

15. Assembly according to claim 1, wherein the base supports a deployable-retractable projection screen.

16. Assembly according to claim 15, wherein this screen is equipped with a drive mechanism which is independent of the movement control system of the mobile sound generation system.

17. Assembly according to claim 16, wherein the screen is acoustically transparent and extends, in its deployed position, in front of the mobile sound generation system in its deployed position.

18. Assembly according to claim 15, wherein the screen is attached to the mobile sound generation system.

19. Assembly according to claim 18, wherein the roll-up retention mechanical device is composed of this screen.

20. Assembly according to claim 18, wherein the roll-up retention mechanical device is located behind the projection screen.

21. Assembly according to claim 1, wherein the mobile sound generation system deploys downwards from the base.

22. Assembly according to claim 1, wherein the mobile sound generation system deploys upwards from the base.

23. Assembly according to claim 1, wherein the base is a cabinet into which the mobile sound generation system can retract in the retracted position.

24. Assembly according to claim 1, wherein the mobile sound generation system is a deployable-retractable sound generation and projection sub-assembly.

25. Assembly according to claim 1, wherein the mobile sound generation system is a platform adapted to receive one or more sound generation devices.

26. Assembly according to claim 2, wherein the roll-up retention device comprises elastic members applying force on this device in the direction of retraction.

27. Assembly according to claim 2, wherein the self-guided stabilization mechanical device comprises arms which are articulated perpendicular to the plane in which this device is deformable.

28. Assembly according to claim 6, wherein the mobile sound generation system deploys downwards from the base.

29. Assembly according to claim 6, wherein the mobile sound generation system deploys upwards from the base.

30. Assembly according to claim 6, wherein the base supports a deployable-retractable projection screen.
